(19) United States
(12) Patent Application Publication
(10) Pub. No.: US 2020/0300458 A1
(43) Pub. Date: Sep. 24, 2020

(54) CANDLE SAFETY SYSTEM

(71) Applicant: Michael COREY, (US)

(72) Inventor: Michael COREY, Joliet, IL (US)

(21) Appl. No.: 16/778,190

(22) Filed: Jan. 31, 2020

Related U.S. Application Data
(60) Provisional application No. 62/820,326, filed on Mar. 19, 2019.

(51) Int. Cl. F23D 3/26; F21V 35/00; F23D 3/16; F23Q 25/00

(52) U.S. Cl. CPC F23D 3/26; F23Q 25/00; F23D 3/16; F21V 35/00

(57) ABSTRACT

A candle safety system including a body portion, a gate, a set of springs, a set of tracks, a set of locks and a transmitter and a receiver to communicate with a user and other candle safety systems.

### CROSS-REFERENCE TO RELATED APPLICATION

This application claims benefit of U.S. Provisional Application No. 62/820,326, filed Mar. 19, 2019, the contents of which are hereby incorporated herein by reference.

### BACKGROUND

### Field of the Invention

The present invention relates to a candle safety system that can be used in a variety of different ways. More particularly, the present invention relates to a candle safety system that enables users to extinguish candles. The candle safety system is designed to enable users to safely extinguish candles without blowing on the candles. Additionally, the candle safety system can be automated and include a timer to release a locking mechanism to extinguish a candle by depriving the fire of the candle of oxygen. The candle safety system can also be controlled remotely.

### Background Information

Many users enjoy using candles for the light they provide. Others enjoy scented candles for the pleasurable smells. Many users enjoy both the light and smells of candles. One drawback is that users need to be present to extinguish the candle. Another drawback is that users may forget to extinguish candles.

### SUMMARY

It has been found that a need exists for a candle safety system that allows users to extinguish a candle or candles without blowing it or them out. The need also exists for an automated system that can extinguish a candle to extend the life of the candle and to assure that the candle is timely extinguished.

Additionally, it has been found that there exists a need for a candle safety system that can remotely extinguish a candle.

It has also been found that there exists a need for a candle safety system that can timely extinguish a candle automatically.

In view of the state of the known technology, inone aspect of the invention, a candle safety system comprises a body portion configured to hold a candle or candles, a gate configured to open and close the body portion where closing the body portion creates a lack of oxygen, a timer to control the closing of the gate.

In another aspect of the invention, the body portion of the candele safety system can be sized or shaped in several different ways to accept candles of various sizes and shapes.

In another aspect of the invention, the candle safety system is linked to one or more other candle safety systems. The candle safety systems can be linked wirelessly, using existing electrical wiring or network wiring. The candle safety systems can be linked in any number of ways available to connect to other electronic appliances and devices.

Further, by including a reservoir portion, the candle safety system can provide the user an easy place to capture used wax to recycle and create new candles.

### BRIEF DESCRIPTION OF THE DRAWINGS

The invention will be explained in more detail hereinafter with reference to the drawings.

FIG. 1 is a perspective views of one embodiment of a candle safety system.

FIG. 2 is a perspective view of the candle safety system of FIG. 1 with the gate in the open position.

FIG. 3 is a perspective view of the candle safety system of FIG. 1 illustrating the gate moving to the closed position.

FIG. 4 is a perspective view of the candle safety system of FIG. 1 with the gate in the closed position.

FIG. 5 is a schematic representation of one embodiment of the candle safety system.

### DETAILED DESCRIPTION OF THE EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

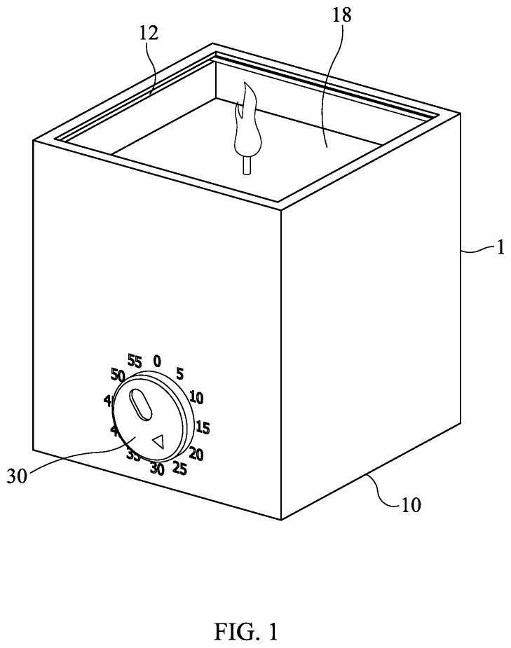

FIGS. 1-4 illustrate an embodiment of the present invention. The candle safety system 1 comprises a body portion 10, a reservoir portion 20, and a timer 30. The components of the candle safety system 1 such as the body portion 10, gate 11, reservoir portion 20, timer 30, and others can be made of various materials. The different components of the candle safety system 1 can be made of metal. Preferably, at least some of the components of the candle safety system 1 are made of a heat-resistant material such as ceramic. More preferably, at least some of the components of the candle safety system 1 are made of a fireproof material.

The body portion 10 is the main portion of this embodiment and has sides and a bottom to hold a candle 18 and an opening to allow the candle to remain lit. The body portion 10 can also include a reservoir portion 20 to collect wax. The reservoir portion 20 can be connected in a variety of ways to the body portion 10 including being connected directly under the body portion 10 or directly behind the body portion 10. The reservoir portion 20 will also have an opening that will allow easy removal of any collected melted wax. The timer 30 is attached to the body portion 10 and enables a user to set a release of the gate 11 at a set time period. The timer 30 can be mechanical or electronic. The timer 30 allows the user to set a predetermined amount of time after which the timer 30 will send a signal to an element on the body portion 10. After the body portion 10 receives a signal to close the gate 11, the gate 11 is closed. In another view the disclosed embodiment is shown with a gate 11 in the open position. The candle safety system 1 comprises a body portion 10, a gate 11, a set of tracks 12 for the gate 11, a set of springs 13, and a magnetic strip 14. The gate 11 can be made of any material. The gate 11 can be made of metal. The gate 11 is attached to the body portion 10. Preferably, the gate 11 is made of a heat-resistant material, and more preferably, a fire-resistant or fireproof material. The gate 11 moves along a set of tracks 12 set in the body portion 10. The gate 11 in the open position compresses a set of springs 13 attached to the body portion 10. The set of springs 13 can be in attached in line with the tracks 12 or set in a different manner. The set of springs 13 is compressed when the gate 11 is in the open position. The gate 11 is released manually or after a set amount of time. The springs 13 push the gate 11 along the track 12 into a closed position. The magnetic strip 14 is attached to the gate 11 and is configured to attract and attach to the body portion 10. The gate 11 in the closed position extinguishes the candle 18 by depriving the flame of oxygen. The magnetic strip 14 provides additional support to create a better closure or seal so that the flame is deprived of oxygen quickly.

In another view the disclosed embodiment is shown with a gate 11 in the closed position. The gate 11 in the closed position covers the candle 18 and does not allow oxygen to feed the candle flame or lessens the oxygen available for the candle. The magnetic strip 14 attached to the gate is configured to better seal or close the opening over the candle portion 18. The seal need not be perfect or airtight. The seal only needs to be sufficient to extinguish the candle. Further, the motion of the gate 11 moving from the closed to the open position can also potentially extinguish the candle flame.

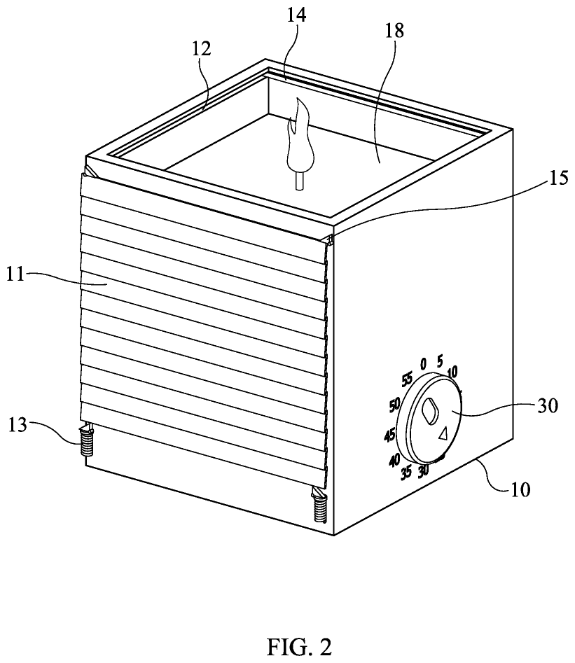

FIG. 2 is another perspective view of a disclosed embodiment of the invention. The candle safety system 1 comprises a body portion 10, a gate 11, a set of tracks 12 for the gate 11, a set of springs 13, a set of locks 15, a timer 30, and a magnetic strip 14. The gate 11 in the open position compresses a set of springs 13. The set of locks 15 is attached to the body portion 10 and maintains the gate 11 in the open position until the user releases the gate 11. The user can release the set of locks 15 to place the gate 11 in a closed position manually. The user can release the set of locks 15 to place the gate 11 in a closed position remotely. The user can release the set of locks 15 to place the gate 11 in a closed position at a predetermined time period by setting the timer 30. The springs 13 push the gate 11 along the track 12 into a closed position. The magnetic strip 14 is attached to the gate 11 and is configured to attach to the body portion 10. The gate 11 in the closed position extinguishes the candle 18 by depriving the flame of oxygen or by extinguishing the flame due to the motion of the gate 11 from the open to the closed position—the movement in the air may blow out the candle. The magnetic strip 14 provides additional support to create a better closure or seal so that the flame is deprived of oxygen.

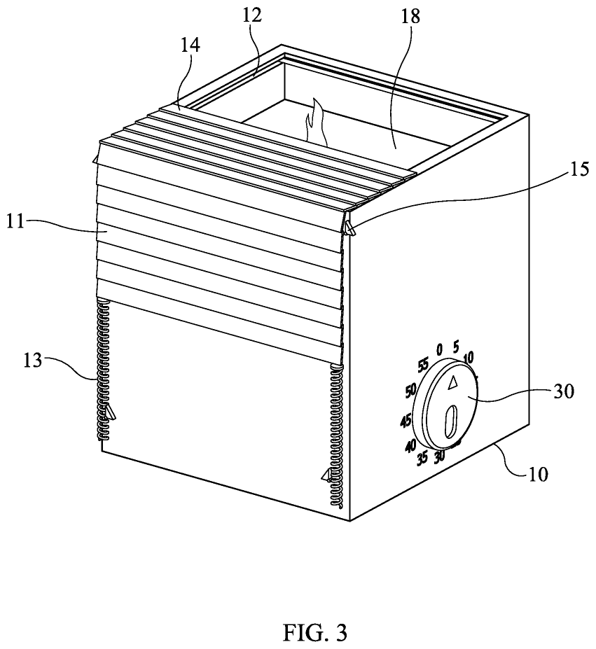

FIG. 3 is another perspective view of a disclosed embodiment of the invention. The candle safety system comprises a body portion 10, a gate 11, a set of tracks 12 for the gate 11, a set of springs 13, a set of locks 15, a timer 30, and a magnetic strip 14. As the gate 11 moves along the tracks 12 of the body portion 10, the gate 11 should start to cover the opening of the body portion 10 where the candle flame sits. The magnetic strip 14 is configured to connect with the body portion 10 when the gate 11 is in the closed position. Conversely, the magnetic strip 14 can be a part of the body portion 10.

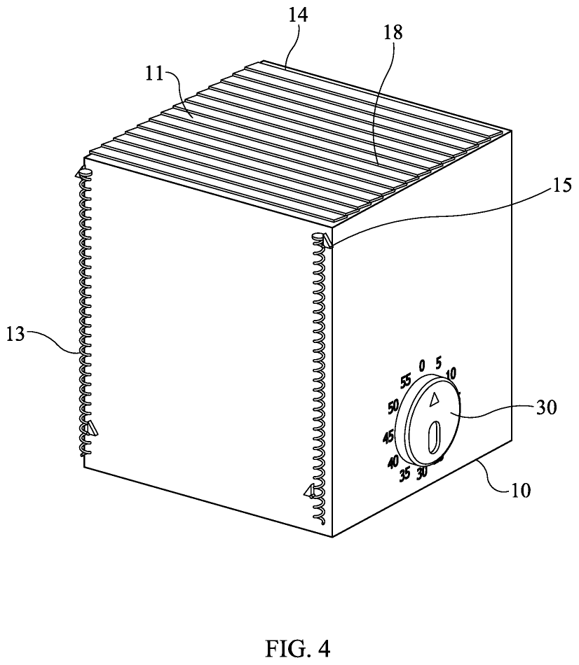

FIG. 4 is another perspective view of a disclosed embodiment of the invention in the closed position. As the gate 11 moves along the tracks 12 of the body portion 10, the gate 11 should start to cover the opening of the body portion 10 where the candle 18 flame sits. The magnetic strip 14 is configured to connect with the body portion 10 when the gate 11 is in the closed position. Other ways of better closing the gate 11 can be used such as a tab and slot connection, or a hook closure, or another comparable closure mechanism known to those skilled in the art. No closure is necessary. The gate 11 in the closed position can sufficiently extinguish the flame without any closure.

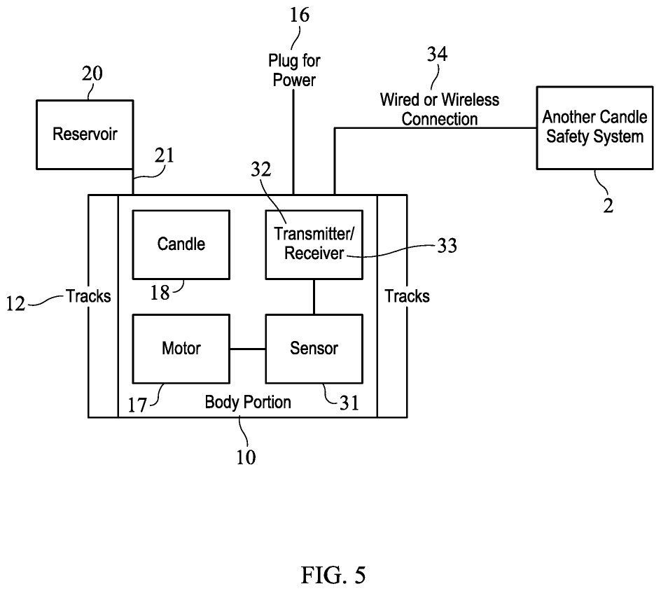

FIG. 5 is a schematic view of a disclosed embodiment of the invention. The candle safety system 1 comprises a body portion 10, a gate 11, a set of tracks 12, a sensor 31, a candle 18, a transmitter 32, a receiver 33, a power source 16, a motor 17, a release 21, a reservoir 20, and a connection 34 to another candle safety system 2 which can include one or more candle safety systems. The body portion 10 comprises tracks 12 for the gate 11 to close. The motor 17 is configured to close the gate 11. However, a motor 17 is not needed for all embodiments. In certain embodiments, the spring can use portions of the body portion a The sensor 31 monitors the temperature levels in the body portion 10. The sensor 19 can also monitor levels of different gases and other chemicals. The sensor 19 can also monitor electronic data. The sensor 19 can also monitor smoke data. The transmitter 32 and receiver 33 are configured to communicate and cooperate with other candle safety systems. The transmitter 32 and receiver 33 is also configured to communicate with a user or users. The power source 16 can be a plug for power or batteries or other power source. One potential power source would be a power source that charges electrically using heat. The release 21 is configured to transfer melted wax to a reservoir 20 which removes wax from the body portion 10. The melted wax can be reused or easily thrown away.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” or “element” when used in the singular can have the dual meaning of a single part or a plurality of parts. Also as used herein to describe the above embodiments, directional terms refer to those directions of a vehicle equipped with the pet food container. Accordingly, these terms, as utilized to describe the present invention should be interpreted relative to a vehicle equipped with the pet food container.

The term “configured” as used herein to describe a component, section or part of a device includes hardware and/or software that is constructed and/or programmed to carry out the desired function.

The terms of degree such as “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A candle safety system comprising:
a body portion comprising a base and an opening; and
a gate configured to move into a closed position or an open position over the opening of the body portion, the gate further configured to extinguish a candle flame.

2. The candle safety system of claim 1 further comprising a set of springs to assist in moving the gate along a set of tracks.

3. The candle safety system of claim 2 further comprising a set of locks for the gate to maintain the gate in the open position.

4. The candle safety system of claim 1 further comprising a motor to move the gate between the open position and the closed position.

5. The candle safety system of claim 1 further comprising a timer configured to communicate with the gate in a closed position after a predetermined time period.

6. The candle safety system of claim 1 further comprising a transmitter and a receiver to provide communication with the candle safety system.

7. The candle safety system of claim 1 further comprising a communication connection between the candle safety system and another candle safety system, the another candle safety system comprising one or more candle safety systems.

8. The candle safety system of claim 1 further comprising a reservoir portion to collect wax.

9. The candle safety system of claim 1 further comprising a temperature sensor.

10. The candle safety system of claim 1 further comprising a gas sensor.

11. The candle safety system of claim 1 further comprising an electronic sensor.

12. The candle safety system of claim 1 further comprising a power source.

13. The candle safety system of claim 1 further comprising a smoke sensor.
